(19) United States
(12) Patent Application Publication
(10) Pub. No.: US 2017/0155739 A1
(43) Pub. Date: Jun. 1, 2017

(54) ADVERTISEMENT DATA PROCESSING METHOD AND ROUTER

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventor: Weibo AO, Beijing (CN)

(73) Assignees: LE HOLDINGS (BEIJING) CO., LTD., Beijing (CN); LE SHI INTERNET INFORMATION & TECHNOLOGY CORP., BEIJING, Beijing (CN)

(21) Appl. No.: 15/243,499

(22) Filed: Aug. 22, 2016

Related U.S. Application Data
(63) Continuation of application No. PCT/CN2016/089704, filed on Jul. 11, 2016.

(30) Foreign Application Priority Data
Dec. 1, 2015 (CN) 201510869052.7

(51) Int. Cl. H04L 29/08; G06Q 30/02

(52) U.S. Cl. CPC H04L 67/327; H04L 67/36; G06Q 30/0267; G06Q 30/0261

(57) ABSTRACT

The present disclosure provides a method for processing advertisement data and a router. The method for processing advertisement data includes: receiving a data download request that is sent by a terminal device and that carries advertisement location data; retrieving whether advertisement content data that is associated with the advertisement location data is stored locally; forwarding the data download request to a content delivery network CDN server, when no the advertisement content data is stored locally; and receiving the advertisement content data that is sent by the CDN server according to the advertisement location data, and implement associative storing of the advertisement location data and the advertisement content data.

### CROSS-REFERENCE TO RELATED DISCLOSURES

The present disclosure is a continuation of PCT application No. PCT/CN2016/089704 submitted on Jul. 11, 2016, and the present disclosure claims priority to Chinese Patent Application No. 201510869052.7, filed with the Chinese Patent Office on Dec. 1, 2015, which is incorporated herein by reference in its entirety.

### TECHNICAL FIELD

The present disclosure relates to Internet technologies, and in particular, to a method for processing advertisement data and a router.

### BACKGROUND

With popularity of Internet multimedia technologies, watching online video content has gradually become a very important part of people's work, study, entertainment, and life. Accordingly, playing an advertisement before or during a video has gradually become a common and important advertising manner.

FIG. 1 is an exemplary schematic diagram of a process of processing advertisement data in the prior art, referring to FIG. 1. The inventor finds during implementation of the present disclosure that a multimedia device such as a smart television or a mobile terminal usually needs to acquire an advertisement link address from an advertisement server, and send a request to a content delivery network (Content Delivery Network, CDN) for downloading a content file (for example, a picture or a video) corresponding to the advertisement link address. It can be seen that the CDN server needs to be accessed each time when the advertisement content file is downloaded, which imposes heavy load on the CDN server and occupies a large amount of bandwidth, leading to a slow transmission speed and poor transmission stability.

### SUMMARY

An objective of the present disclosure is to provide a method for processing advertisement data and a router, so as to implement associative storing of advertisement location data and advertisement content data, and the data can be directly acquired when a terminal device requires for the data again, thereby improving a data transmission speed and stability.

According to the first aspect of this present disclosure, an embodiment of this present disclosure provides a method for processing advertisement data. The method includes: receiving a data download request that is sent by a terminal device and that carries advertisement location data; retrieving whether advertisement content data that is associated with the advertisement location data is stored locally; forwarding the data download request to a content delivery network CDN server, when no the advertisement content data is stored locally; and receiving the advertisement content data that is sent by the CDN server according to the advertisement location data, and implementing associative storing of the advertisement location data and the advertisement content data.

According to the second aspect, an embodiment of this present disclosure further provides a non-volatile computer storage medium, which stores a computer executable instructions that, when executed by an electronic apparatus, cause the electronic apparatus to perform an above disclosed method.

According to the third aspect, an embodiment of this present disclosure further provides a router, including: at least one processor; and a memory for storing instructions executable by the at least one processor, wherein execution of the instructions by the at least one processor causes the at least one processor to perform the above method for processing advertisement data of this present disclosure.

### BRIEF DESCRIPTION OF THE DRAWINGS

One or more embodiments are exemplarily described by using figures that are corresponding thereto in the accompanying drawings; the exemplary descriptions do not form a limitation to the embodiments. Elements with same reference signs in the accompanying drawings are similar elements. Unless otherwise particularly stated, the figures in the accompanying drawings do not form a scale limitation.

FIG. 1 is an exemplary schematic diagram of a process of processing advertisement data in the prior art;

FIG. 2 is a flowchart of a method for processing advertisement data according to some embodiments of the present disclosure; and

FIG. 3 is a logical block diagram of a router according to some embodiments of the present disclosure; and

FIG. 4 is a schematic structural diagram of hardware of a router according to some embodiments of this present disclosure.

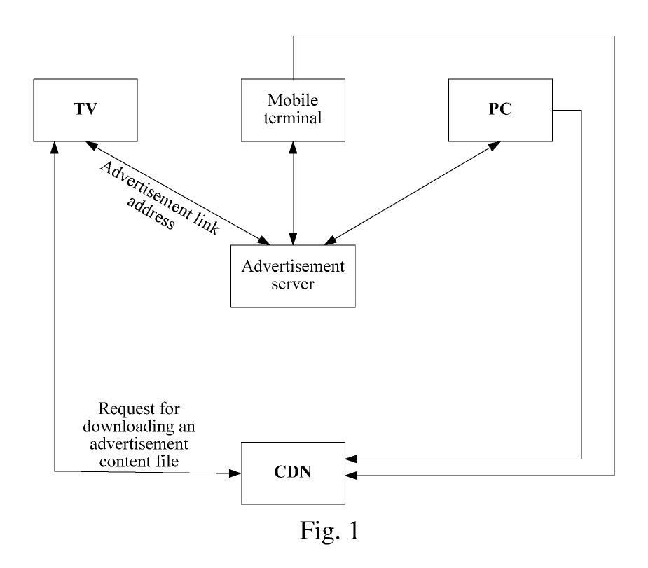

### DETAILED DESCRIPTION

A basic concept of embodiments of the present disclosure is to provide a technical solution to process advertisement data. A router receives a data download request sent by a terminal device, where the data download request carries advertisement location data, retrieving whether advertisement content data corresponding to the advertisement location data is stored locally, and if no advertisement content data is stored locally, the data download request is forwarded to a CDN server to acquire the advertisement content data, so as to implement associative storing of the advertisement location data and the advertisement content data. The data can be directly acquired from the router when a terminal device requires for the data again, and there is no need to access the CDN server, thereby improving a data transmission speed and stability, reducing load of the CDN server, and saving bandwidth resources.

The following describes a method for processing advertisement data and a router in exemplary embodiments of the present disclosure in detail with reference to the accompanying drawings.

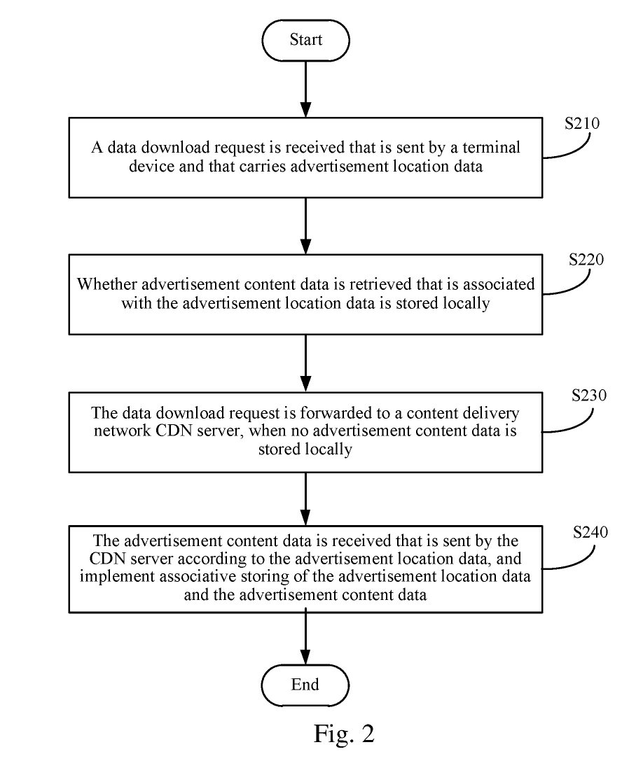

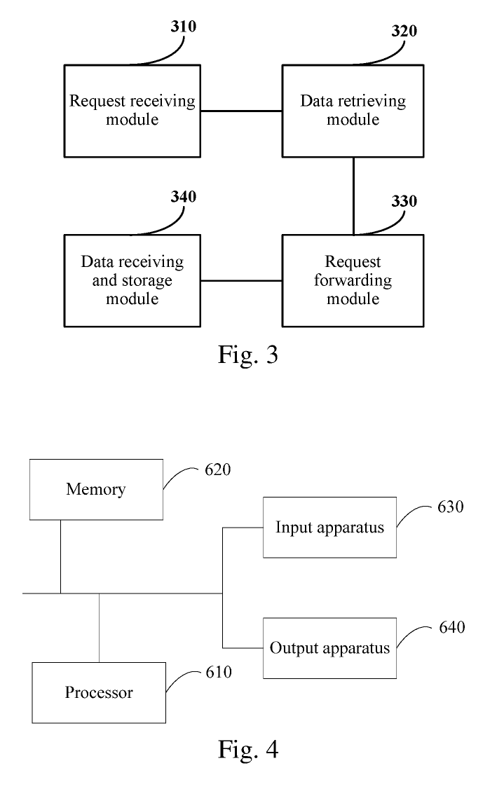

FIG. 2 is a flowchart of a method for processing advertisement data according to Embodiment 1 of the present disclosure. Steps of the method for processing advertisement data are executed by a router shown in FIG. 3.

Referring to FIG. 2, in step S210, a data download request is received that is sent by a terminal device and that carries advertisement location data.

The terminal device may be a cell phone, a tablet computer, a smart television, or the like. It should be noted that the advertisement location data may be a uniform resource locator URL indicating a download link address of advertisement content data.

In Step S220, whether advertisement content data is retrieved that is associated with the advertisement location data is stored locally.

That is, after the advertisement location data is acquired, local storage is retrieved according to the advertisement location data to determine whether advertisement content data corresponding to the advertisement location data is stored. The advertisement content data herein may include but is not limited to at least one of the following media contents: a text, a picture, or a video.

In Step S230, the data download request is forwarded to a content delivery network CDN server, when no the advertisement content data is stored locally.

Specifically, if advertisement content data corresponding to the advertisement location data is not retrieved by locally retrieving, the router forwards the data download request to the CDN server, so as to acquire the advertisement content data by accessing the CDN server.

In Step S240, the advertisement content data is received that is sent by the CDN server according to the advertisement location data, and implement associative storing of the advertisement location data and the advertisement content data.

After the processing of steps S210 to S230, the advertisement content data that is acquired, according to the advertisement location data, and sent by the CDN server is received, further, a correspondence between the advertisement location data and the advertisement content data is established so as to store in an associated manner.

When the advertisement location data and the advertisement content data are stored in an associated manner, the acquired advertisement content data also needs to be fed back to the terminal device sending the request. Therefore, the method may further include: sending the advertisement content data that is acquired from the CDN server to the terminal device.

To reduce load of the CDN server, on the premise that the advertisement content data corresponding to the advertisement location data is stored in a router, according to a preferred embodiment of this present disclosure, the method further includes: sending, the advertisement content data which is retrieved, to the terminal device, when the advertisement content data is stored locally.

According to the method for processing advertisement data provided in this embodiment, a data download request sent by a terminal device is received, where the data download request carries advertisement location data, it is retrieved whether advertisement content data corresponding to the advertisement location data is stored locally, and if no advertisement content data is stored, the data download request is forwarded to a CDN server to acquire the advertisement content data, so as to implement associative storing of the advertisement location data and the advertisement content data. When a new terminal device requires for the data, the advertisement content data corresponding to the advertisement location data that is carried in the request can be directly obtained, and there is no need to access the CDN server, thereby improving a data transmission speed and stability, reducing load of the CDN server, and saving bandwidth resources.

Based on the same technical concept, FIG. 3 is a logical block diagram of a router according to some embodiments of this present disclosure. Referring to FIG. 3, the router includes a request receiving module 310, a data retrieving module 320, a request forwarding module 330, and a data receiving and storage module 340, where the request receiving module 310, the data search module 320, the request forwarding module 330, and the data receiving and storage module 340 are connected in order.

The request receiving module 310 is configured to receive a data download request that is sent by a terminal device and that carries advertisement location data.

The data retrieving module 320 is configured to retrieve whether advertisement content data that is associated with the advertisement location data is stored locally.

The request forwarding module 330 is configured to forward the data download request to a content delivery network CDN server, when no advertisement content data is stored locally.

The data receiving and storage module 340 is configured to: receive the advertisement content data that is sent by the CDN server according to the advertisement location data, and implement associative storing of the advertisement location data and the advertisement content data.

According to the router provided in this embodiment, a data download request sent by a terminal device is received, it is further retrieve whether advertisement content data corresponding to advertisement location data in the data download request is stored locally, and when no advertisement content data is stored, the data download request is forwarded to a CDN server to acquire the advertisement content data, so as to implement associative storing of the advertisement location data and the advertisement content data, and the data can be directly acquired when a terminal device requires for the data again, thereby improving a data transmission speed and stability.

To reduce load of the CDN server and save bandwidth resources, on the premise that the advertisement content data corresponding to the advertisement location data is stored in the router, the data can be directly acquired from the router. Accordingly, the router may further include: a data sending module (not shown in a figure), configured to send, the advertisement content data which is retrieved, to the terminal device, when the advertisement content data is stored locally.

Further, the data sending module is further configured to send the advertisement content data that is acquired from the CDN server to the terminal device.

In some embodiments, the advertisement location data is a uniform resource locator URL indicating a download link address of the advertisement content data.

In some embodiments, the advertisement content data includes at least one of the following media content: a text, a picture, or a video.

It should be noted that according to the needs of implementations, each part/step described in the present disclosure may be divided into more parts/steps, or two or more parts/steps or some operations of parts/steps may be combined into a new part/step, so as to achieve the objective of the embodiments of this present disclosure.

Some embodiments of this present disclosure provides a non-volatile computer storage medium, which stores computer executable instructions, where the computer executable instructions can execute the method for processing advertisement data in any one of the foregoing method embodiments.

FIG. 4 is a schematic structural diagram of hardware of a router for executing a method for processing advertisement data according to some embodiments of this present disclosure. As shown in FIG. 4, the router includes: one or more processors 610 and a memory 620, where only one processor 610 is used as an example in FIG. 4.

The router for executing the method for processing advertisement data may further include: an input apparatus 630 and an output apparatus 640.

The processor 610, the memory 620, the input apparatus 630, and the output apparatus 640 can be connected by means of a bus or in other manners. A connection by means of a bus is used as an example in FIG. 4.

As a non-volatile computer readable storage medium, the memory 420 can be used to store non-volatile software programs, non-volatile computer executable programs and modules, for example, program instructions/module corresponding to the method for processing advertisement data in the embodiments of this present disclosure (for example, the request receiving module 310, the data retrieving module 320, the request forwarding module 330, and the data receiving and storage module 340 shown in FIG. 3). The processor 610 executes various functional disclosures and data processing of a server, that is, implements the method for processing advertisement data of the foregoing method embodiments, by running the non-volatile software programs, instructions, and modules that are stored in the memory 620.

The memory 620 may include a program storage area and a data storage area, where the program storage area may store an operating system and a disclosure that is needed by at least one function; the data storage area may store data created according to use of the router, and the like. In addition, the memory 620 may include a high-speed random access memory, or may also include a non-volatile memory such as at least one disk storage device, flash storage device, or another non-volatile solid-state storage device. In some embodiments, the memory 620 optionally includes memories that are remotely disposed with respect to the processor 610, and the remote memories may be connected, via a network, to the router. Examples of the foregoing network include but are not limited to: the Internet, an intranet, a local area network, a mobile communications network, or a combination thereof.

The input apparatus 630 can receive entered digits or character information, and generate key signal inputs relevant to user setting and functional control of the router. The output apparatus 640 may include a display device, for example, a display screen.

The one or more modules are stored in the memory 620; when the one or more modules are executed by the one or more processors 610, the method for processing advertisement data in any one of the foregoing method embodiments is executed.

The foregoing product can execute the method provided in the embodiments of this present disclosure, and has corresponding functional modules for executing the method and beneficial effects. Refer to the method provided in the embodiments of this disclosure for technical details that are not described in detail in this embodiment.

The router in this embodiment of this present disclosure exists in multiple forms, including but not limited to:

(1) Mobile communication device: such devices are characterized by having a mobile communication function, and primarily providing voice and data communications; terminals of this type include: a smart phone (for example, an iPhone), a multimedia mobile phone, a feature phone, a low-end mobile phone, and the like;

(2) Ultra mobile personal computer device: such devices are essentially personal computers, which have computing and processing functions, and generally have the function of mobile Internet access; terminals of this type include: PDA, MID and UMPC devices, and the like, for example, an iPad;

(3) Portable entertainment device: such devices can display and play multimedia content; devices of this type include: an audio and video player (for example, an iPod), a handheld game console, an e-book, an intelligent toy and a portable vehicle-mounted navigation device;

(4) Server: a device that provides a computing service; a server includes a processor, a hard disk, a memory, a system bus, and the like; an architecture of a server is similar to a universal computer architecture. However, because a server needs to provide highly reliable services, requirements for the server are high in aspects of the processing capability, stability, reliability, security, extensibility, and manageability; and

(5) Other electronic apparatuses having a data interaction function.

The apparatus embodiment described above is merely exemplary, and units described as separated components may be or may not be physically separated; components presented as units may be or may not be physical units, that is, the components may be located in a same place, or may be also distributed on multiple network units. Some or all modules therein may be selected according to an actual requirement to achieve the objective of the solution of this embodiment.

Through description of the foregoing implementation manners, a person skilled in the art can clearly learn that each implementation manner can be implemented by means of software in combination with a universal hardware platform, and certainly, can be also implemented by using hardware. Based on such understanding, the essence, or in other words, a part that makes contributions to relevant technologies, of the foregoing technical solutions can be embodied in the form of a software product. The computer software product may be stored in a computer readable storage medium, for example, a ROM/RAM, a magnetic disk, or a compact disc, including several instructions for enabling a computer device (which may be a personal computer, a sever, or a network device, and the like) to execute the method in the embodiments or in some parts of the embodiments.

Finally, it should be noted that: the foregoing embodiments are only used to describe the technical solutions of this present disclosure, rather than limit this disclosure. Although this present disclosure is described in detail with reference to the foregoing embodiments, a person of ordinary skill in the art should understand that he/she can still modify technical solutions disclosed in the foregoing embodiments, or make equivalent replacements to some technical features therein; however, the modifications or replacements do not make the essence of corresponding technical solutions depart from the spirit and scope of the technical solutions of the embodiments of this present disclosure.

What is claimed is:

1. A method for processing advertisement data, applied to a router, comprising:
receiving a data download request that is sent by a terminal device and that carries advertisement location data;
retrieving whether advertisement content data that is associated with the advertisement location data is stored locally;
forwarding the data download request to a content delivery network CDN server, when no the advertisement content data is stored locally; and
receiving the advertisement content data that is sent by the CDN server according to the advertisement location data, and implementing associative storing of the advertisement location data and the advertisement content data.

2. The method according to claim 1, further comprising:
sending, the advertisement content data which is retrieved, to the terminal device, when the advertisement content data is stored locally.

3. The method according to claim 1, further comprising:
sending the advertisement content data that is acquired from the CDN server to the terminal device.

4. The method according to claim 1, wherein the advertisement location data is a uniform resource locator URL indicating a download link address of the advertisement content data.

5. The method according to claim 1, wherein the advertisement content data comprises at least one of the following media content: a text, a picture, or a video.

6. A non-volatile computer storage medium storing executable instructions that, when executed by an electronic device with a touch-sensitive display, cause the electronic device to:
receive a data download request that is sent by a terminal device and that carries advertisement location data;
retrieve whether advertisement content data that is associated with the advertisement location data is stored locally;
forward the data download request to a content delivery network CDN server, when no advertisement content data is stored locally; and
receive the advertisement content data that is sent by the CDN server according to the advertisement location data, and implement associative storing of the advertisement location data and the advertisement content data.

7. The non-volatile computer storage medium according to claim 6, wherein the computer executable instructions are further configured to:
send the found advertisement content data to the terminal device, when the advertisement content data is stored locally.

8. The non-volatile computer storage medium according to claim 6, wherein the computer executable instructions are further configured to:
send the advertisement content data that is acquired from the CDN server to the terminal device.

9. The non-volatile computer storage medium according to claim 6, wherein the advertisement location data is a uniform resource locator URL indicating a download link address of the advertisement content data.

10. The non-volatile computer storage medium according to claim 6, wherein the advertisement content data comprises at least one of the following media content: a text, a picture, or a video.

11. A router, comprising:
at least one processor; and
a memory communicably connected with the at least one processor for storing instructions executable by the at least one processor,
wherein execution of the instructions by the at least one processor causes the at least one processor to:
receive a data download request that is sent by a terminal device and that carries advertisement location data;
retrieve whether advertisement content data that is associated with the advertisement location data is stored locally;
forward the data download request to a content delivery network CDN server, when no advertisement content data is stored locally; and
receive the advertisement content data that is sent by the CDN server according to the advertisement location data, and implement associative storing of the advertisement location data and the advertisement content data.

12. The router according to claim 11, wherein execution of the instructions further causes the at least one processor to:
send the retrieved advertisement content data to the terminal device, when the advertisement content data is stored locally.

13. The router according to claim 11, wherein execution of the instructions further causes the at least one processor to:
send the advertisement content data that is acquired from the CDN server to the terminal device.

14. The router according to claim 11, wherein the advertisement location data is a uniform resource locator URL indicating a download link address of the advertisement content data.

15. The router according to claim 11, wherein the advertisement content data comprises at least one of the following media content: a text, a picture, or a video.
